(19) United States
(12) Patent Application Publication
(10) Pub. No.: US 2009/0189975 A1
(43) Pub. Date: Jul. 30, 2009

(54) APPARATUS AND METHOD FOR GENERATING FILE, APPARATUS AND METHOD FOR REPRODUCING THREE-DIMENSIONAL SHAPE, AND PROGRAMS THEREFOR

(76) Inventors: Satoshi YANAGITA, Kurokawa-gun (JP); Satoshi Nakamura, Kurokawa-gun (JP); Youichi Sawachi, Kurokawa-gun (JP); Eiji Ishiyama, Kurokawa-gun (JP); Tomonori Masuda, Kurokawa-gun (JP)

Correspondence Address: BIRCH STEWART KOLASCH & BIRCH, PO BOX 747, FALLS CHURCH, VA, 22040-0747, US

(21) Appl. No.: 12/357,561

(22) Filed: Jan. 22, 2009

(30) Foreign Application Priority Data
Jan. 25, 2008 (JP) 014596/2008

(51) Int. Cl. H04N 13/02

(52) U.S. Cl. 348/47; 348/E13.074

(57) ABSTRACT

A file generation apparatus comprises three-dimensional data acquisition means for obtaining a three-dimensional data set comprising distance data representing a three-dimensional shape of a subject, data conversion means for generating a converted three-dimensional data set by arranging the distance data according to distance, and generation means for identifying the distance data at a boundary in the case where the converted three-dimensional data set is divided at predetermined distance intervals and for generating a three-dimensional data file storing the converted three-dimensional data set and storage location information representing a storage location of the identified distance data in the file.

### BACKGROUND OF THE INVENTION

1. Field of the Invention

The present invention relates to an apparatus and a method for generating a three-dimensional data file from three-dimensional data representing a three-dimensional shape of a subject, to an apparatus and a method for reproducing the three-dimensional shape from the three-dimensional data file, and to programs for causing a computer to execute the file generation method the three-dimensional shape reproduction method.

2. Description of the Related Art

A method has been proposed for generating a three-dimensional image representing a three-dimensional shape of a subject according to the steps of photographing the subject by using two or more cameras installed at different positions, searching (that is, carrying out stereo matching) for pixels corresponding to each other between images obtained by the photography (a reference image obtained by a reference camera and a matching image obtained by a matching camera), and by measuring a distance from either the reference camera or the matching camera to a single point on the subject corresponding to a pixel through application of triangulation using a difference (that is, a parallax) between a position of the pixel in the reference image and a position of the corresponding pixel in the matching image.

Data of a three-dimensional image generated in this manner (three-dimensional data) have been stored for reuse, separately from image data (two-dimensional image data) of the reference image and the matching image. However, if the three-dimensional data are stored separately from the two-dimensional image data, the data of the two types generated for the same purpose need to be managed separately. Therefore, a method of outputting one data file by including three-dimensional data in two-dimensional image data has been proposed (see Japanese Unexamined Patent Publication No. 2005-077253 and International Patent Publication No. WO2003/92304).

However, the method described in Japanese Unexamined Patent Publication No. 2005-077253 or International Patent Publication No. WO2003/92304 generates only one data file by inclusion of three-dimensional data in two-dimensional image data. Therefore, in the case where reproduction of a three-dimensional shape of only a specific distance range is desired, for example, the distance range needs to be judged after reading all the three-dimensional data from the data file, which leads to long reproduction time for the three-dimensional shape and for a two-dimensional image.

### SUMMARY OF THE INVENTION

The present invention has been conceived based on consideration of the above circumstances, and an object of the present invention is to enable easy reproduction of a three-dimensional shape in a desired distance range from a three-dimensional data file.

A file generation apparatus of the present invention comprises:

three-dimensional data acquisition means for obtaining a three-dimensional data set comprising distance data representing a three-dimensional shape of a subject;

data conversion means for generating a converted three-dimensional data set by arranging the distance data according to distance; and

generation means for identifying the distance data at a boundary in the case where the converted three-dimensional data set is divided at predetermined distance intervals and for generating a three-dimensional data file storing the converted three-dimensional data set and storage location information representing a storage location of the identified distance data in the file.

Arranging the distance data according to distance refers to arranging the distance data in ascending or descending order of distance.

The storage location information can be stored in the three-dimensional data file by being described in a header thereof, for example.

In the file generation apparatus of the present invention, the generation means may divide the converted three-dimensional data set at the predetermined intervals only in a range from a closest distance and a farthest distance among distances represented by the distance data.

In the case where the three-dimensional data set is generated from two-dimensional image data sets obtained by photographing the subject, the file generation apparatus of the present invention may further comprise two-dimensional image data acquisition means for obtaining the two-dimensional image data sets. In this case, the generation means generates the three-dimensional data file by relating one or more of the two-dimensional image data sets to the converted three-dimensional data set.

Generating the three-dimensional data file by relating one or more of the two-dimensional image data sets to the converted three-dimensional data set refers to generating the three-dimensional data file in such a manner that the two-dimensional image data set or sets is/are integrated and inseparable from the converted three-dimensional data set. More specifically, the manner of generation refers not only to the case where the two-dimensional image data set or sets and the converted three-dimensional data set are combined and stored in the three-dimensional data file but also to the case where the three-dimensional data file storing only the converted three-dimensional data set and a two-dimensional data file or two-dimensional data files storing only the two-dimensional image data set or sets are generated as distinctive files whose file names are the same but whose extensions are different, for example.

In this case, the three-dimensional data acquisition means may obtain the three-dimensional data set by generating the three-dimensional data set from the two-dimensional image data sets.

Furthermore, the generation means in this case may generate the three-dimensional data file by adding information on pixel positions in an image represented by one of the two-dimensional image data sets to the distance data at the pixel positions.

In the case where the distance data corresponding to a portion of the pixel positions in the image represented by the two-dimensional image data set cannot be obtained, the generation means may delete the distance data corresponding to the portion of the pixel positions.

In the case where the distance data representing the same distance exist at a plurality of positions, the data conversion means in this case may arrange the distance data in order of the corresponding pixel positions in the image represented by the two-dimensional image data set.

A three-dimensional shape reproduction apparatus of the present invention comprises:

file acquisition means for obtaining the three-dimensional data file generated by the file generation apparatus of the present invention;

specification means for receiving specification of a reproduction distance range regarding the three-dimensional shape, based on the storage location information included in the three-dimensional data file; and

reproduction means for obtaining a three-dimensional data set comprising the distance data corresponding to only the reproduction distance range from the three-dimensional data file and for reproducing an image of the three-dimensional shape represented by the three-dimensional data set of the reproduction distance range.

In the case where the two-dimensional image data sets are obtained, another three-dimensional shape reproduction apparatus of the present invention comprises:

file acquisition means for obtaining the three-dimensional data file generated by the file generation apparatus of the present invention;

specification means for receiving specification of a reproduction distance range regarding the three-dimensional shape, based on the storage location information included in the three-dimensional data file; and

reproduction means for obtaining a three-dimensional data set comprising the distance data corresponding to only the reproduction distance range from the three-dimensional data file and a corresponding portion of the two-dimensional image data set or sets related to the three-dimensional data set of the reproduction distance range, and for reproducing an image of the three-dimensional shape represented by the three-dimensional data set of the reproduction distance range and a two-dimensional image represented by the portion of the two-dimensional image data set or sets.

A file generation method of the present invention comprises the steps of:

obtaining a three-dimensional data set comprising distance data representing a three-dimensional shape of a subject;

generating a converted three-dimensional data set by arranging the distance data according to distance;

identifying the distance data at a boundary in the case where the converted three-dimensional data set is divided at predetermined distance intervals; and

generating a three-dimensional data file storing the converted three-dimensional data set and storage location information representing a storage location of the identified distance data in the file.

In the case where the three-dimensional data set is generated from two-dimensional image data sets obtained by photographing the subject, the file generation method of the present invention may further comprise the step of obtaining the two-dimensional image data sets. In this case, the step of generating the three-dimensional data file is the step of generating the three-dimensional data file by relating one or more of the two-dimensional image data sets to the converted three-dimensional data set.

A three-dimensional shape reproduction method of the present invention comprises the steps of:

obtaining the three-dimensional data file generated by the file generation method of the present invention;

receiving specification of a reproduction distance range regarding the three-dimensional shape, based on the storage location information included in the three-dimensional data file;

obtaining a three-dimensional data set comprising the distance data corresponding to only the reproduction distance range from the three-dimensional data file; and

reproducing an image of the three-dimensional shape represented by the three-dimensional data set of the reproduction distance range.

In the case where the two-dimensional image data sets are obtained, another three-dimensional shape reproduction method of the present invention comprises the steps of:

obtaining the three-dimensional data file generated by the file generation method of the present invention;

receiving specification of a reproduction distance range regarding the three-dimensional shape, based on the storage location information included in the three-dimensional data file;

obtaining a three-dimensional data set comprising the distance data corresponding to only the reproduction distance range from the three-dimensional data file and a corresponding portion of the two-dimensional image data set or sets related to the three-dimensional data set of the reproduction distance range; and

reproducing an image of the three-dimensional shape represented by the three-dimensional data set of the reproduction distance range and a two-dimensional image represented by the portion of the two-dimensional image data set or sets.

The file generation method and the three-dimensional shape reproduction methods of the present invention may be provided as programs that cause a computer to execute the methods.

According to the file generation apparatus and method of the present invention, the distance data at the boundary are identified in the case where the converted three-dimensional data set comprising the distance data arranged in order of distance is divided at the predetermined intervals and the three-dimensional data file storing the converted three-dimensional data set and the storage location information representing the storage location of the identified distance data in the file is generated. Therefore, by referring to the storage location information in the three-dimensional data file, the distance data at the boundary of the predetermined intervals can be identified. Consequently, the three-dimensional data set comprising the distance data only in a desired distance range can be easily obtained from the three-dimensional data file, and the image of the three-dimensional shape in the desired distance range can be easily reproduced.

In addition, by dividing the converted three-dimensional data set at the predetermined intervals only in the range from the closest distance to the farthest distance in the distances represented by the distance data, the three-dimensional data file can be generated only in the range of the existing distance data. Therefore, an amount of data in the three-dimensional data file can be reduced.

Furthermore, in the case where the three-dimensional data set is generated from the two-dimensional image data sets obtained by photographing the subject, the two-dimensional image data sets and the three-dimensional data set generated for the same purpose can be managed easily by generating the three-dimensional data file relating one or more of the two-dimensional image data sets and the converted three-dimensional data set.

In this case, by obtaining the three-dimensional data set from the two-dimensional image data sets, installation of an apparatus for separately generating the three-dimensional data set becomes unnecessary.

Moreover, generation of the three-dimensional data file by adding the pixel position information in the image represented by the two-dimensional image data set to the distance data at the pixel positions enables easy correlation between the two-dimensional image and the three-dimensional shape at the time of reproduction.

In this case, if the distance data corresponding to a portion of the pixel positions in the image represented by the two-dimensional image data set cannot be obtained, the amount of data in the three-dimensional data file can be reduced by deletion of the distance data corresponding to the portion of the pixel positions.

In the case where the distance data representing the same distance exist at a plurality of positions, confusion associated with arrangement of the distance data representing the same distance can be avoided by arranging the distance data in order of the corresponding pixel positions in the image represented by the two-dimensional image data set.

### BRIEF DESCRIPTION OF THE DRAWINGS

FIG. 1 is a block diagram showing a schematic internal configuration of a stereo camera adopting a file generation apparatus and a three-dimensional shape reproduction apparatus of a first embodiment of the present invention;

FIG. 2 shows the configuration of imaging units;

FIG. 3 shows stereo matching;

FIG. 4 shows positional relationships between a reference image and a matching image after rectification processing;

FIG. 5 shows a coordinate system for distance data at the time of photography in the first embodiment;

FIG. 6 shows an occluded point;

FIG. 7 is a flow chart showing processing carried out in the first embodiment;

FIG. 8 shows an information input screen;

FIG. 9 shows division of a distance range in the first embodiment;

FIG. 10 shows a file structure in a three-dimensional data file F0;

FIG. 11 shows the content of a header in the first embodiment;

FIG. 12 shows how an image data set G1 and a converted three-dimensional data set V1 are stored in the three-dimensional data file F0;

FIG. 13 is a flow chart showing processing carried out at the time of reproduction of the three-dimensional data file F0;

FIG. 14 shows a reproduction range selection screen;

FIG. 15 shows a confirmation screen for a three-dimensional shape and a two-dimensional image;

FIG. 16 shows a deletion confirmation screen;

FIG. 17 is a flow chart showing processing carried out in a second embodiment of the present invention;

FIG. 18 shows division of a distance range in the second embodiment; and

FIG. 19 shows the content of a header in the second embodiment.

### DESCRIPTION OF THE PREFERRED EMBODIMENTS

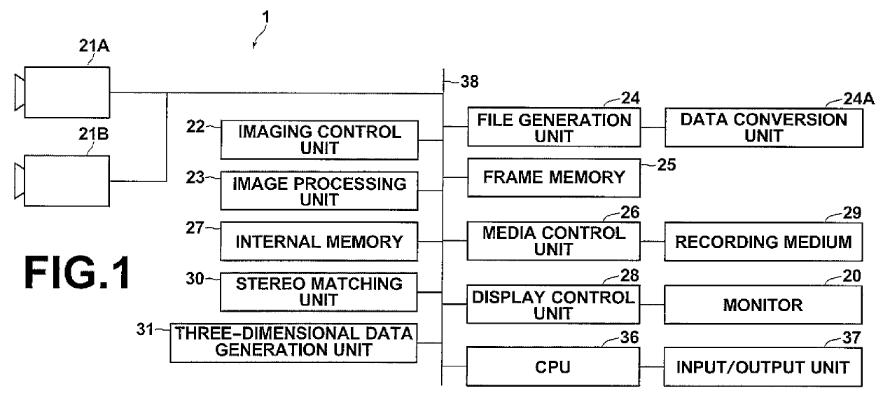

Hereinafter, embodiments of the present invention will be described with reference to the accompanying drawings. FIG. 1 is a block diagram showing a schematic internal configuration of a stereo camera 1 adopting a file generation apparatus and a three-dimensional shape reproduction apparatus of a first embodiment of the present invention. As shown in FIG. 1, the stereo camera 1 in the first embodiment comprises two imaging units 21A and 21B, an imaging control unit 22, an image processing unit 23, a file generation unit 24, a frame memory 25, a media control unit 26, an internal memory 27, and a display control unit 28.

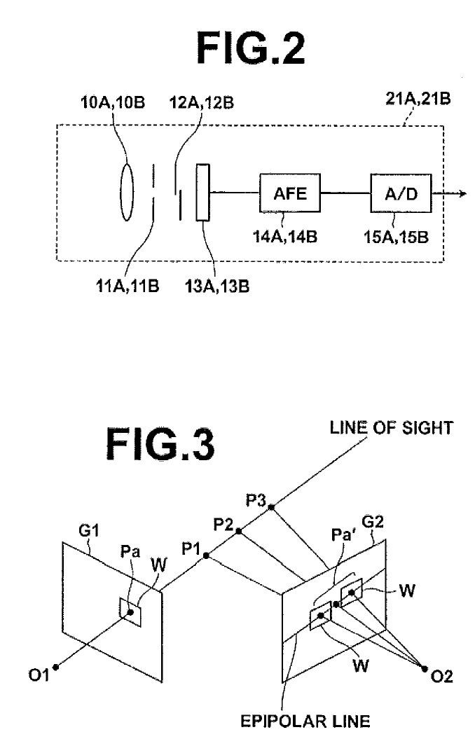

FIG. 2 shows the configuration of the imaging units 21A and 21B. As shown in FIG. 2, the imaging units 21A and 21B respectively have lenses 10A and 10B, irises 11A and 11B, shutters 12A and 12B, CCDs 13A and 13B, analog front ends (AFE) 14A and 14B, and A/D conversion units 15A and 15B.

Each of the lenses 10A and 10B comprises a plurality of lenses carrying out different functions, such as a focus lens for focusing on a subject and a zoom lens for realizing a zoom function. Positions of the lenses are adjusted by a lens driving unit which is not shown. In this embodiment, a focal position of each of the lenses is fixed.

The irises 11A and 11B are subjected to iris diameter adjustment processing carried out by an iris driving unit which is not shown, based on iris value data obtained by AE processing. In this embodiment, the iris value data are fixed.

The shutters 12A and 12B are mechanical shutters and driven by a shutter driving unit which is not shown, according to a shutter speed obtained in the AE processing. In this embodiment, the shutter speed is fixed.

Each of the CCDs 13A and 13B has a photoelectric plane having a multiple of light receiving elements laid out two-dimensionally. A light from the subject is focused on the plane and subjected to photoelectric conversion to generate an analog image signal. In front of the CCDs 13A and 13B, color filters having filters regularly arranged for R, G, and B colors are located.

The AFEs 14A and 14B carry out processing for removing noise from the analog image signals outputted from the CCDs 13A and 13B, and processing for adjusting gains of the analog image signals (hereinafter the processing by the AFEs is referred to as analog processing).

The A/D conversion units 15A and 15B convert the analog image signals having been subjected to the analog processing by the AFEs 14A and 14B into digital signals. Image data sets generated by conversion of the signals obtained by the CCDs 13A and 13B in the imaging units 21A and 21B into the digital signals are RAW data having R, G, and B density values of each of pixels. Hereinafter, a two-dimensional image represented by an image data set obtained by the imaging unit 21A is referred to as a reference image G1 while a two-dimensional image represented by an image data set obtained by the imaging unit 21B is referred to as a matching image G2. In the description below, the image data sets of the reference image and the matching image are also denoted by G1 and G2, respectively.

The imaging control unit 22 carries out imaging control after a release button has been pressed.

In this embodiment, the focal position, the iris value data, and the shutter speed are fixed. However, the focal position, the iris value data, and the shutter speed may be set by AF processing and AE processing at each time of photography.

The image processing unit 23 carries out correction processing for correcting variance in sensitivity distribution in image data and for correcting distortion of the optical systems on the image data sets G1 and G2 obtained by the imaging units 21A and 21B, and carries out rectification processing thereon for causing the two images to be parallel. The image processing unit 23 also carries out image processing such as white balance adjustment processing, gradation correction, sharpness correction, and color correction on the images having been subjected to the rectification processing. Hereinafter, the reference and matching images and the image data sets having been subjected to the image processing by the image processing unit 23 are also denoted by G1 and G2.

The file generation unit 24 generates a three-dimensional data file F0 from the image data set CG of the reference image having been subjected to the processing by the image processing unit 23 and from a converted three-dimensional data set V1 representing a three-dimensional shape of the subject generated as will be described later. The image data set G1 and the converted three-dimensional data set V1 in the three-dimensional data file F0 have been subjected to compression processing necessary therefor. Based on Exif format or the like, the three-dimensional data file F0 is added with a header describing accompanying information such as time and date of photography and addresses of the converted three-dimensional data set V1 that will be described later. The file generation unit 24 has a data conversion unit 24A for generating the converted three-dimensional data set V1 by arranging distance data in ascending order of distance as will be described later. The processing carried out by the file generation unit 24 will be described later in detail.

The frame memory 25 is a memory as workspace used at the time of execution of various processing including the processing by the image processing unit 23 on the image data sets representing the reference and matching images G1 and G2 obtained by the imaging units 21A and 21B and on the converted three-dimensional data set.

The media control unit 26 carries out reading writing control of the three-dimensional data file F0 by accessing a recording medium 29.

The internal memory 27 stores various kinds of constants set in the stereo camera 1, programs executed by a CPU 36, and the like.

The display control unit 28 is to display on a monitor 20 the image data sets stored in the frame memory 25 and a three-dimensional image as an image of the three-dimensional shape of the subject represented by the converted three-dimensional data set V1 included in the three-dimensional data file F0 stored in the recording medium 29.

The stereo camera 1 also has a stereo matching unit 30 and a three-dimensional data generation unit 31.

As shown in FIG. 3, the stereo matching unit 30 searches for points corresponding to each other in the reference image G1 and the matching image G2, based on the fact that pixels Pa′ in the matching image G2 corresponding to a pixel Pa in the reference image G1 exist on a straight line (epipolar line) as maps of points P1, P2, P3, and so on in an actual space, since the points P1, P2, P3, and so on that are mapped on the pixel Pa in the reference image G1 exist on a line of sight from a point O1. In FIG. 3, the point O1 is a viewpoint of the imaging unit 21A serving as a reference camera while a point O2 is a viewpoint of the imaging unit 21B serving as a matching camera. The viewpoints refer to focal points of the optical systems of the imaging units 21A and 21B. In order to search for the corresponding points, the reference image G1 and the matching image G2 having been subjected to only the rectification processing are preferably used although the reference image G1 and the matching image G2 having been subjected to the image processing may be used. Hereinafter, the corresponding points are searched for regarding the reference image G1 and the matching image G2 before the image processing.

More specifically, at the time of search for the corresponding points, the stereo matching unit 30 moves a predetermined correlation window W along the epipolar line, and calculates correlation between pixels in the correlation window W in the reference and matching images G1 and G2 at each position of the window W. The stereo matching unit 30 determines that the point corresponding the pixel Pa in the reference image G1 is a pixel at the center of the correlation window W in the matching image G2 at a position at which the correlation becomes largest. As a value to evaluate the correlation, a sum of absolute values of differences between pixel values or a square sum of the differences may be used, for example. In these cases, the smaller the correlation evaluation value is, the larger the correlation is.

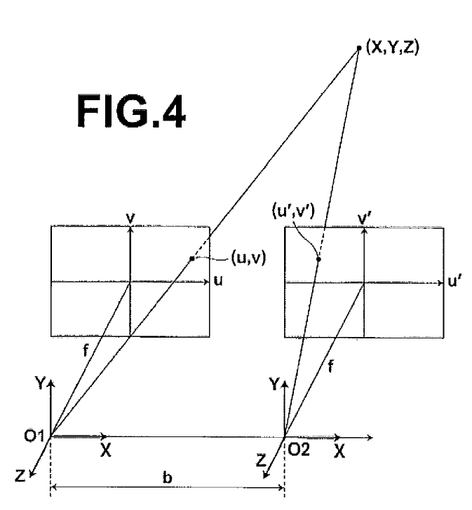

FIG. 4 shows positional relationships between the reference image and the matching image after the rectification processing. As shown in FIG. 4, the planes on which the reference image G1 and the matching image G2 are obtained in the imaging units 21A and 21B have origins at intersections with optical axes of the imaging units 21A and 21B, respectively. Coordinate systems of the imaging units 21A and 21B in the image planes are referred to as (u, v) and (u′, v′), respectively. Since the optical axes of the imaging units 21A and 21B are parallel after the rectification processing, the u axis and the u′ axis in the image planes are oriented to the same direction on the same line. In addition, since the epipolar line in the matching image G2 becomes parallel to the u′ axis after the rectification processing, the direction of the u axis in the reference image G1 also coincides with the direction of the epipolar line of the matching image G2.

Let f and b respectively denote a focal length and a baseline length of the imaging units 21A and 21B. The focal length f and the baseline length b have been calculated in advance as calibration parameters and stored in the internal memory 27. At this time, distance data (X, Y, Z) representing a position on the subject in a three-dimensional space are expressed by following Equations (1) to (3) with reference to the coordinate system of the imaging unit 21A:

X=b·u/(u−u′) (1)

Y=b·v/(u−u′) (2)

Z=b·f/(u−u′) (3)

where the term (u−u′) is a horizontal difference (that is, a parallax) between corresponding projected points in the image planes of the imaging units 21A and 21B.

By calculating the distance data (X, Y, Z) at a plurality of positions in the above manner in the three-dimensional space, the shape of the subject in the three-dimensional space can be represented, and a set of the distance data is a three-dimensional data set V0. The symbols X and Y in the distance data represent a position on the subject while the symbol Z represents a distance thereof. The distance data are calculated only in a range that is common between the reference image G1 and the matching image G2. As shown in FIG. 5, the coordinate system of the three-dimensional data set V0 agrees with the coordinate system of the imaging unit 21A. Therefore, the coordinates (x, y) of each pixel position in the reference image G1 can be related to the distance data (X, Y, Z). In FIG. 5, the Y axis is perpendicular to a surface of the paper. The reference image G1 has the coordinate system whose origin is located at the pixel at the upper left corner thereof and the horizontal and vertical directions are x and y directions, respectively.

The three-dimensional data generation unit 31 calculates the distance data (X, Y, Z) representing the distance from the XY plane at the imaging units 21A and 21B to the subject at a plurality of positions in the three-dimensional space according to Equations (1) to (3) above by using the corresponding points found by the stereo matching unit 30, and generates the three-dimensional data set V0 comprising the distance data (X, Y, Z) having been calculated.

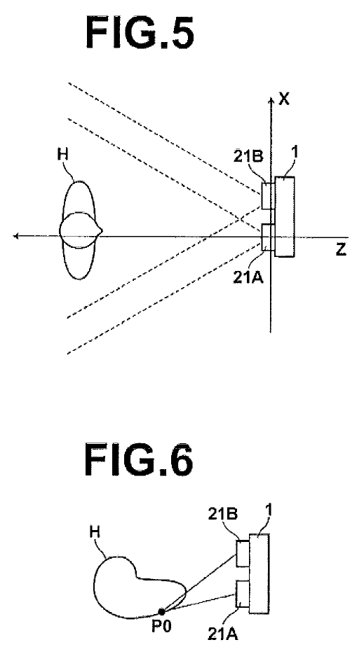

As shown in FIG. 6, an occluded point P0 that can be seen from the imaging unit 21A but cannot be seen from the imaging unit 21B exists in some cases, depending on a shape of a subject H. For the occluded point P0, whether the distance data therefor exist is not obvious since the distance data (X, Y, Z) cannot be calculated. In addition, the distance data cannot be calculated in a range in the reference image G1 that is not common with the matching image G2. Therefore, in this embodiment, for the points whose distance data (X, Y, Z) cannot be calculated in the three-dimensional space, non-calculation of the distance data can be understood by giving the value FF (in the case where X, Y, and Z are represented by hexadecimal numbers) to values of X, Y, and Z (that is, (X, Y, Z)=(FF, FF, FF)).

The CPU 36 controls each of the units in the stereo camera 1 according to a signal from an input/output unit 37.

The input/output unit 37 comprises various kinds of interfaces, operation buttons such a switch and the release button operable by a photographer, and the like.

A data bus 38 is connected to each of the units of the stereo camera 1 and to the CPU 36, to exchange various kinds of data and information in the stereo camera 1.

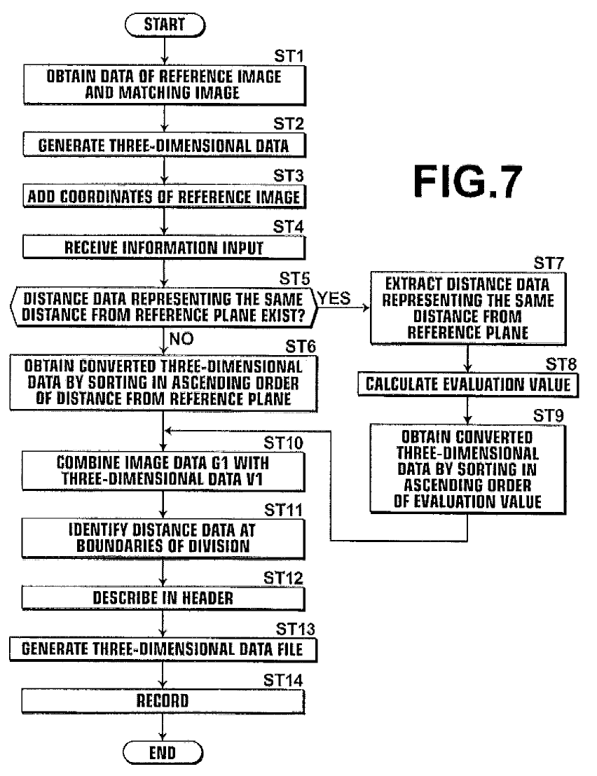

Processing carried out in the first embodiment will be described next. FIG. 7 is a flow chart showing the processing carried out in the first embodiment. The processing described here is carried out after photography has been instructed by full press of the release button.

The CPU 36 starts the processing in response to the full press of the release button, and the imaging units 21A and 21B photograph the subject according to an instruction from the CPU 36. The image processing unit 23 carries out the correction processing, the rectification processing, and the image processing on the image data sets obtained by the imaging units 21A and 21B, to obtain the image data sets G1 and G2 of the reference image and the matching image (Step ST1). The stereo matching unit 30 finds the corresponding points, and the three-dimensional data generation unit 31 generates the three-dimensional data set V0 based on the corresponding points having been found (Step ST2).

Thereafter, the file generation unit 24 adds the coordinates (x, y) of the pixel position in the reference image G1 to the corresponding distance data (X, Y, Z) in the three-dimensional data set V0 (Step ST3). In this manner, the distance data included in the three-dimensional data set V0 are related to the positions of corresponding pixels in the reference image G1, and the distance data comprise (x, y, X, Y, Z).

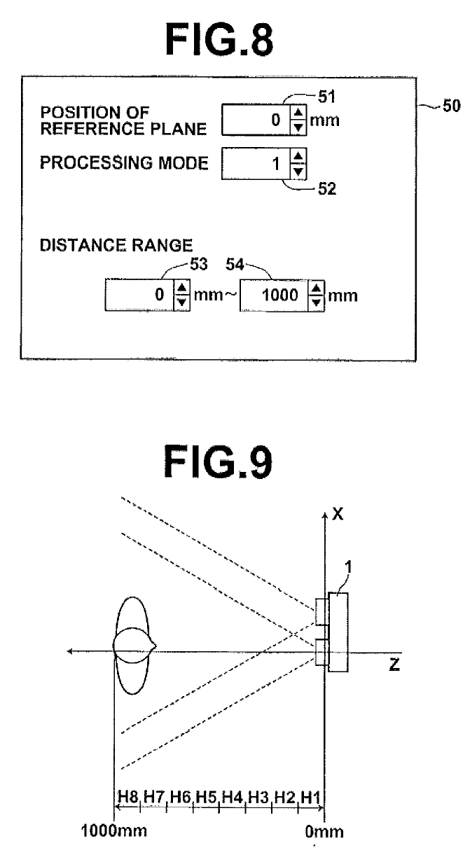

In response to an instruction from the CPU 36, the display control unit 28 displays an information input screen on the monitor 20, and receives inputs from the input/output unit 37 for specification of a position of a plane used as a distance reference at the time of generation of the three-dimensional data file F0, a processing mode, and a distance range (reception of information input: Step ST4). FIG. 8 shows the information input screen. As shown in FIG. 8, first to fourth input boxes 51 to 54 for inputting the reference plane position, the processing mode, and the distance range are displayed in an information input screen 50.

The reference plane is a plane perpendicular to the Z axis in the coordinate system shown in FIG. 5 and used as the reference at the time of arranging the distance data in order of distance as will be described later. A distance from the stereo camera 1 is inputted as the reference plane position. FIG. 8 shows the state where 0 mm has been inputted as the reference plane position.

A plurality of processing modes can be set as the processing mode for generating the three-dimensional data file F0 in the stereo camera 1. The photographer specifies the processing mode by inputting a number thereof, for example. The content of the processing modes will be described later. FIG. 8 shows the state wherein “1” has been inputted as the processing mode.

The distance range is a distance range of the three-dimensional data set V0 to be stored in the three-dimensional data file F0. The photographer specifies the distance range by inputting a minimum and a maximum of a desired distance range of the three-dimensional data set V0 to be included in the three-dimensional data file F0. FIG. 8 shows the state wherein 0 mm to 1000 mm has been inputted as the distance range.

Small up and down triangular buttons are added to each of the first to fourth input boxes 51 to 54, and the photographer can change values to be inputted in the input boxes 51 to 54 by pressing the triangular buttons up and down with use of the operation buttons of the input/output unit 37.

The data conversion unit 24A then judges presence or absence of the distance data (X, Y, Z) whose distance from the reference plane is the same (that is, the distance data having the same Z value), regarding the distance data (x, y, X, Y, Z) added with the coordinates of the reference image G1 (Step ST5). If a result of the judgment at Step ST5 is negative, the distance data in the distance range inputted in the above manner are arranged in ascending order of distance from the reference plane, and the converted three-dimensional data set V1 is obtained (Step ST6).

If the result at Step ST5 is affirmative, the distance data representing the same distance from the reference plane are extracted (Step ST7), and an evaluation value E0 is calculated based on the coordinates of the reference image G1 added to the extracted distance data (Step ST8). The evaluation value E0 is the number of pixels from the origin at the upper left corner of the reference image G1 to the coordinates. More specifically, the evaluation value E0 is calculated as E0=(the number of pixels in the horizontal direction in the reference image G1)×y+x, by using the coordinates (x, y) of the reference image G1. The data conversion unit 24A obtains the converted three-dimensional data set V1 by arranging the distance data representing the same distance from the reference plane in ascending order of the evaluation value E0 (Step ST9).

After Steps ST6 and ST9, the file generation unit 24 integrates the image data set G1 and the converted three-dimensional data set V1 into one file (Step ST10). At this time, the distance data (x, y, X, Y, Z) whose X, Y, and Z values are FF are deleted. The file generation unit 24 divides the distance range inputted by the photographer by a predetermined number, and identifies the distance data at boundaries of the divided distance (Step ST11). In this embodiment, the predetermined number is 8. The distance data at the boundaries are distance data representing the farthest distance in each of the divided distance ranges. However, the distance data may be distance data representing the closest distance thereof.

The file generation unit 24 then describes an address of the last distance data in each of the divided distance ranges and necessary information in the header (Step ST12), and generates the three-dimensional data file F0 (Step ST13). The media control unit 26 records the three-dimensional data file F0 in the recording medium 29 (Step ST14) to end the processing.

The necessary information includes the numbers of pixels in the horizontal and vertical directions of the reference image G1, the starting address of the data set for the reference image G1, the starting address of the converted three-dimensional data set V1, the ending address of the converted three-dimensional data set V1, the position of the reference plane, the distance range inputted by the photographer, the closest distance in the converted three-dimensional data set V1 and the address of the distance data thereof, the farthest distance in the converted three-dimensional data set V1 and the address of the distance data thereof, intervals of the divided distance ranges, file name, time and date of photography, and the like.

In this embodiment, the reference plane is Z=0 (that is, the XY plane), and the distance range is 0 to 1000 mm. The predetermined number for division of the distance range is 8. Therefore, as shown in FIG. 9, the distance range from 0 mm to 1000 mm is evenly divided into 8 ranges H1 to H8 at 125 mm intervals. The distance ranges H1 to H8 refer to 0 mm to less than 125 mm, 125 mm to less than 250 mm, 250 mm to less than 375 mm, 375 mm to less than 500 mm, 500 m to less than 625 μm, 625 mm to less than 750 m, 750 μm to less than 875 mm, and 875 mm to 1000 mm, respectively.

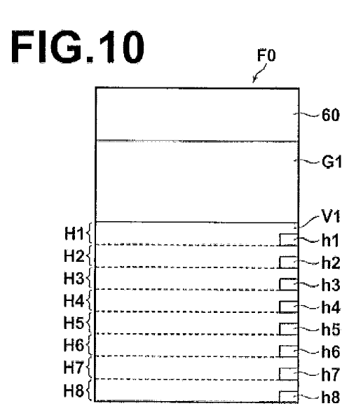

FIG. 10 shows a file structure of the three-dimensional data file F0. As shown in FIG. 10, the three-dimensional data file F0 stores a header 60, the image data set G1, and the converted three-dimensional data set V1. The converted three-dimensional data set V1 has the distance data divided into the 8 ranges H1 to H8 and stored in the three-dimensional data file F0. Addresses h1 to h8 representing the farthest distances in the respective distance ranges H1 to H8 are described in the header 60.

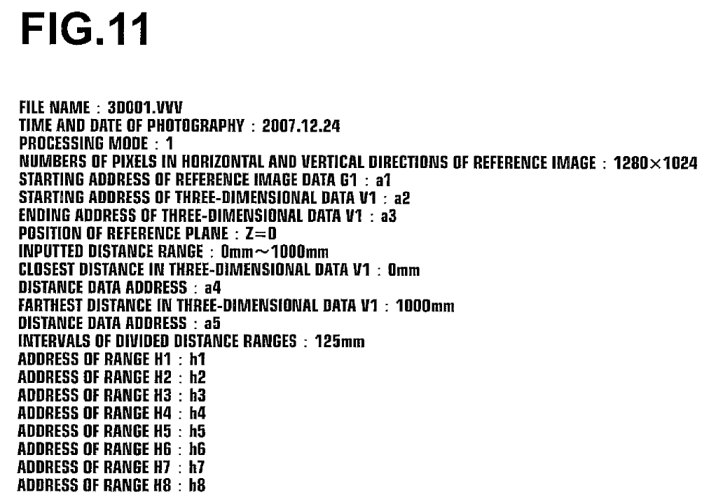

FIG. 11 shows the content of the header 60 in the first embodiment. As shown in FIG. 11, 3D001.VVV as the file name, 2007.12.24 as the time and date of photography, and 1 as the processing mode are described in the header 60. In addition, 1280×1024 as the numbers of pixels in the horizontal and vertical directions of the reference image G1, a1 as the starting address of the reference image data set G1, a2 as the starting address of the converted three-dimensional data set V1, a3 as the ending address of the converted three-dimensional data set V1, Z=0 as the reference plane position, 0 mm to 1000 mm as the inputted distance range, 0 mm as the closest distance in the converted three-dimensional data set V1 and a4 as the address of the distance data, 1000 mm as the farthest distance in the converted three-dimensional data set V1 and a5 as the address of the distance data, 125 mm as the intervals of the divided distance ranges, the addresses h1 to h8 as the last distance data in the respective ranges H1 to H8 are described in the header 60.

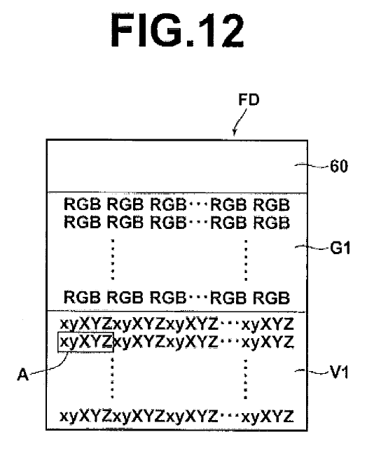

FIG. 12 shows how the image data set G1 and the converted three-dimensional data set V1 are stored in the three-dimensional data file F0. As shown in FIG. 12, RGB values of the respective pixels in the reference image G1 are arranged in order starting from the origin (that is, (x, y)=(0, 0)) in the image data set G1. Three consecutive values correspond to the RGB values of each of the pixels in the reference image G1.

In the converted three-dimensional data set V1, the distance data (x, y, X, Y, Z) are arranged in ascending order of distance from the reference plane. In the case where (X, Y, Z)=(FF, FF, FF), the corresponding distance data (x, y, X, Y, Z) are deleted at the time the converted three-dimensional data set V1 is combined with the image data set G1. For example, when the distance data corresponding to a portion A in FIG. 12 are deleted, the data corresponding to the portion does not exist. Therefore, the following data are moved over.

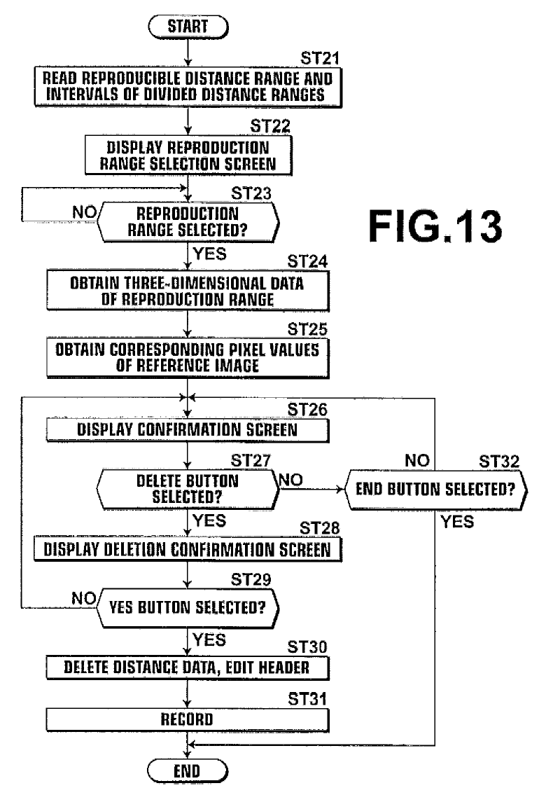

Processing carried out at the time of reproduction of the three-dimensional data file F0 will be described below. FIG. 13 is a flow chart showing the processing carried out at the time of reproduction of the three-dimensional data file F0. The CPU 36 starts the processing when the photographer inputs an instruction to reproduce the three-dimensional data file F0. The CPU 36 reads the three-dimensional data file F0 stored in the recording medium 29, and further reads the reproducible distance range and the intervals of the divided distance ranges from the header of the three-dimensional data file F0 (Step ST21). The display control unit 28 displays a reproduction range selection screen on the monitor 20 (Step ST22).

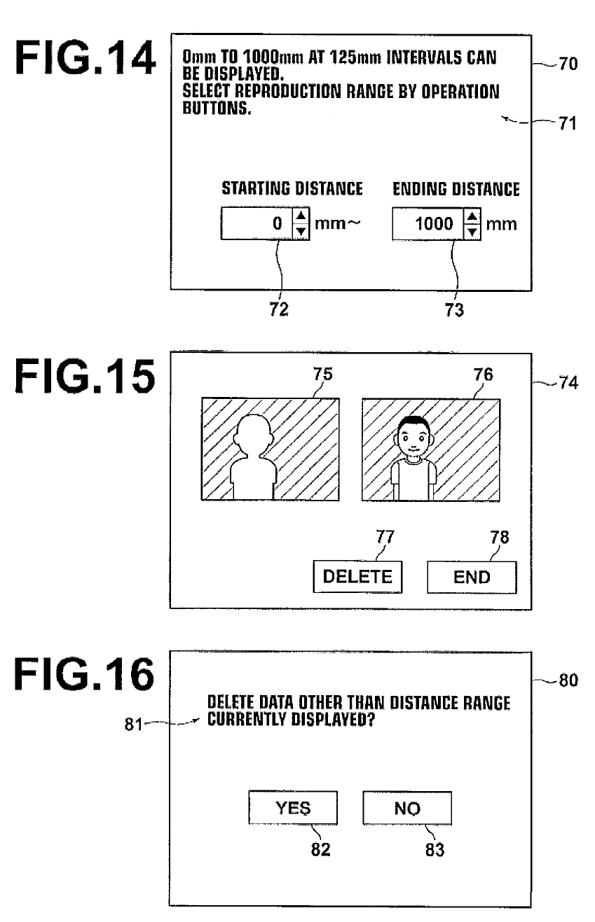

FIG. 14 shows the reproduction range selection screen. As shown in FIG. 14, text 71 describing the reproducible distance range and the intervals of divided distance ranges is displayed in a reproduction range selection screen 70 together with distance range specification boxes 72 and 73 for specifying a distance range to be reproduced. The distance range specification boxes 72 and 73 are to input a reproduction starting distance and a reproduction ending distance, respectively. Small triangular up and down buttons are added to each of the distance range specification boxes 72 and 73, and the photographer can input the reproduction starting and ending distances in the distance range specification boxes 72 and 73 by pressing the buttons up and down with use of the operation buttons of the input/output unit 37. The distances displayed in the distance range specification boxes 72 and 73 are selectable according to the distance range and the intervals of the divided distance ranges described in the header of the three-dimensional data file F0. In this embodiment, the distance can be inputted at 125 mm intervals in the range from 0 mm to 1000 mm.

In response to selection of the reproduction range (Step ST23: YES), the CPU 36 refers to the addresses h1 to h8 of the ranges H1 to H8 described in the header of the three-dimensional data file F0 to obtain from the three-dimensional data file F0 a three-dimensional data set V2 comprising the distance data in the reproduction distance range selected by the photographer (Step ST24). Furthermore, the CPU 36 obtains the pixel values (RGB) of the reference image corresponding to the coordinates of the reference image G1 added to the distance data included in the three-dimensional data set V2 (Step ST25). Based on the pixel values and the three-dimensional data set V2, the display control unit 28 displays on the monitor 20 a confirmation screen of the three-dimensional shape of the subject in the reproduction range selected by the photographer, together with a two-dimensional image thereof (Step ST26).

FIG. 15 shows the confirmation screen of the three-dimensional shape and the two-dimensional image. As shown in FIG. 15, a three-dimensional image 75 as an image of the three-dimensional shape in the selected reproduction range and a two-dimensional image 76 are displayed in a confirmation screen 74. In the images 75 and 76, ranges other than the selected reproduction range are diagonally hatched. Although the three-dimensional image 75 has different colors depending on the distance, the colors are shown as a blank in FIG. 15. A Delete button 77 and an End button 78 are also displayed on the monitor 20.

The CPU 36 judges whether the photographer has selected the Delete button 77 (Step ST27). If a result at Step ST27 is affirmative, the CPU 36 displays a deletion confirmation screen (Step ST28). FIG. 16 shows the deletion confirmation screen. As shown in FIG. 16, text 81 inquiring the photographer whether the data corresponding to a portion other than the reproduced portion are deleted is displayed in a deletion confirmation screen 80, together with YES and NO buttons 82 and 83. The CPU 36 judges whether the YES button 82 has been selected (Step ST29). If a result at Step ST29 is affirmative, the CPU 36 deletes from the three-dimensional data file F0 the distance data other than the distance data included in the three-dimensional data set V2 representing the three-dimensional shape being displayed, and edits the header (Step ST30). The media control unit 26 records in the recording medium 29 the processed three-dimensional data file F0 wherein the corresponding distance data have been deleted and the header has been edited (Step ST31) to end the processing.

If the result at Step ST27 is negative, whether the End button 78 has been selected is judged (Step ST32). If a result at Step ST32 is affirmative, the processing ends. If the result at Step ST32 is negative, the processing flow returns to Step ST26. In the case where the result at Step ST29 is negative, the processing flow also returns to Step ST26.

When the header is edited, a portion of the addresses h1 to h8 and the ranges H1 to H8 corresponding to the deleted distance data is deleted, and the starting address and the ending address of the converted three-dimensional data set V1, the inputted distance range, the closest distance in the three-dimensional data set V1 and the address of the corresponding distance data, and the farthest distance in the converted three-dimensional data set V1 and the address of the corresponding distance data are changed so as to correspond to the three-dimensional data set V2 in the reproduction range.

As has been described above, in this embodiment, the distance data at the boundaries are identified in the case where the converted three-dimensional data set V1 comprising the distance data arranged in order of distance is divided at the predetermined intervals, and the three-dimensional data file F0 storing the converted three-dimensional data set V1 is generated by describing the addresses of the identified distance data in the header. Therefore, by referring to the addresses in the header of the three-dimensional data file F0, the distance data at the boundaries of the predetermined intervals can be identified. Consequently, the converted three-dimensional data set V1 comprising only the distance data at a desired distance range can be easily obtained from the three-dimensional data file F0. As a result, the image of the three-dimensional shape in the desired distance range can be easily reproduced.

Since the converted three-dimensional data set V1 is generated from the image data sets G1 and G2 of the reference image and the matching image obtained by photography of the subject and the three-dimensional data file F0 is generated by relating the reference image data set G1 and the converted three-dimensional data set V1, the image data set G1 and the converted three-dimensional data set V1 generated for the same purpose can be easily managed.

In addition, since the converted three-dimensional data set V1 is generated from the image data sets G1 and G2 of the reference image and the matching image, installation of an apparatus for generating the converted three-dimensional data set V1 is not necessary.

Furthermore, since the three-dimensional data file F0 is generated by adding the coordinates of the positions of the pixels in the image represented by the image data set G1 to the distance data at the pixel positions, the reference image G1 and the three-dimensional shape can be easily related at the time of reproduction.

Moreover, in the case where the distance data corresponding to a pixel position in the reference image G1 cannot be obtained, the distance data are deleted. Therefore, an amount of data can be reduced in the three-dimensional data file F0.

In the case where the distance data representing the same distance correspond to a plurality of positions, the converted three-dimensional data set V1 is generated by arranging the distance data in order of the corresponding pixel positions in the reference image G1. Therefore, confusion at the time of arrangement of the distance data representing the same distance can be avoided.

A second embodiment of the present invention will be described next. Since the configuration of the stereo camera in the second embodiment is the same as the first embodiment and processing carried out by the camera is solely different from the first embodiment, detailed description of the configuration will be omitted. In the second embodiment, a distance range in which a subject exists is found from the three-dimensional data set V0 and the three-dimensional data file F0 is generated only from the distance data in the distance range, which is a difference from the first embodiment.

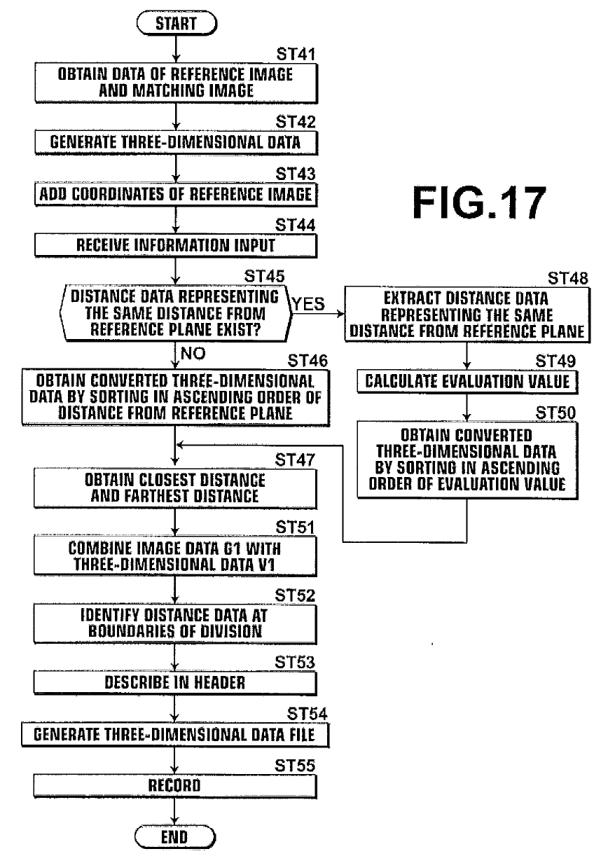

Processing carried out in the second embodiment will be described next. FIG. 17 is a flow chart showing the processing carried out in the second embodiment. Since the processing from Step ST41 to ST43 is the same as the processing at Step ST1 to ST3 in the first embodiment, detailed description thereof will be omitted here.

After Step ST43, the CPU 36 receives specification of the processing mode and the reference plane position used as the reference of distance at the time of generation of the three-dimensional data file F0, as inputs from the input/output unit 37 (reception of information input: Step ST44). In the first embodiment, “1” has been inputted as the processing mode. In the second embodiment, “2” is inputted as the processing mode, since the processing carried out in the second embodiment is different from the first embodiment. In the second embodiment, no input of the distance range is received, since the distance range in which the subject exists is found from the three-dimensional data set V0 to generate the three-dimensional data file F0 from the distance data in the distance range.

The data conversion unit 24A then judges whether the distance data representing the same distance from the reference plane exist in the distance data (x, y, X, Y, Z) added with the coordinates of the reference image G1, as in Step ST5 in the first embodiment (Step ST45). If a result at Step ST45 is negative, the CPU 36 arranges the distance data in ascending order of distance from the reference plane and obtains the converted three-dimensional data set V1 (Step ST46). The CPU 36 obtains the closest and farthest distances in the distance data included in the converted three-dimensional data set V1 (Step ST47).

If the result at Step ST45 is affirmative, processing at Step ST48 to ST50 is carried out in the same manner as the processing at Step ST7 to ST9 in the first embodiment, and the converted three-dimensional data set V1 is obtained. The processing flow then goes to Step ST47 to obtain the closest and farthest distances in the distance data included in the converted three-dimensional data set V1.

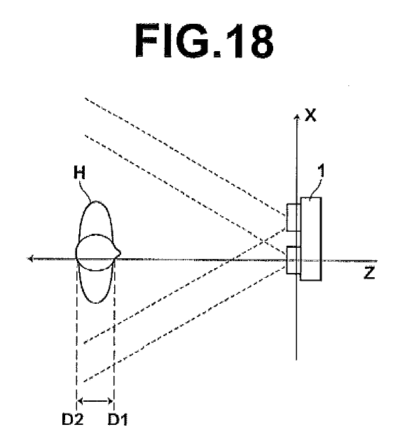

FIG. 18 shows the closest and farthest distances obtained in the second embodiment. As shown in FIG. 18, in the case where a subject H is photographed by the stereo camera 1, the subject H exists only between a distance D1 and a distance D2. Therefore, the distance data are calculated only between the distance D1 and the distance D2. Consequently, the closest and farthest distances are D1 and D2, respectively.

The file generation unit 24 then integrates the image data set G1 and the converted three-dimensional data set V1 into one file (Step ST51). At this time, the distance data (x, y, X, Y, Z) whose X, Y, and Z values are FF are deleted. The file generation unit 24 divides the distance range between the closest distance D1 and the farthest distance D2 by the predetermined number, and identifies the distance data at the boundaries of division (Step ST52). In this embodiment, the predetermined number for division is 8. The distance data at the boundaries refer to the last distance data in each of the divided distance ranges.

The file generation unit 24 describes the addresses of the last distance data in the respective divided distance ranges and the necessary information in the header (Step ST53), and generates the three-dimensional data file F0 (Step ST54). The media control unit 26 records the three-dimensional data file F0 in the recording medium 29 (Step ST55) to end the processing.

In the case where the closest distance D1 and the farthest distance D2 are obtained as shown in FIG. 18, the distance range from D1 to D2 is evenly divided into 8 ranges. More specifically, if the closest distance D1=900 mm and the farthest distance D2=1000 mm, the distance range from 900 mm to 1000 mm is divided into 8 ranges H11 to H18 at 12.5 mm intervals, since the predetermined number for division is 8. The ranges H11 to H18 are from 900 mm to less than 912.5 mm, 912.5 mm to less than 925 mm, 925 mm to less than 937.5 mm, 937.5 mm to less than 950 mm, 950 mm to less than 962.5 mm, 962.5 nm to less than 975 mm, 975 mm to less than 987.5 mm, and 987.5 mm to 1000 mm, respectively.

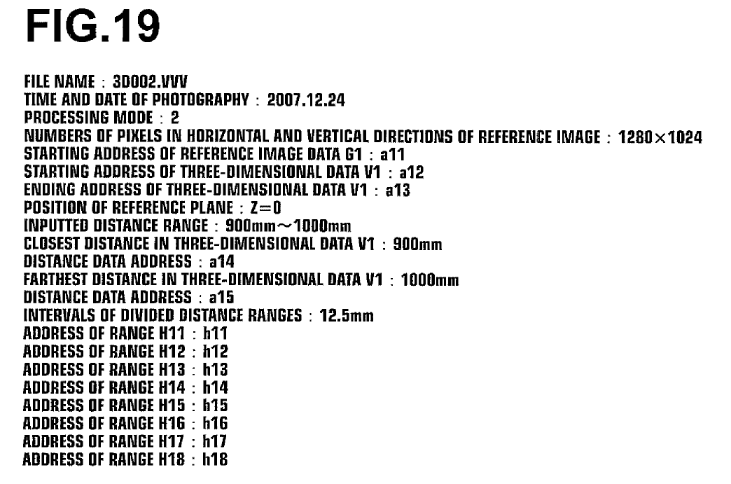

FIG. 19 shows an example of description in the header in the second embodiment. As shown in FIG. 19, 3D002.VVV as the file name, 2007.12.24 as the time and date of photography, and 2 as the processing mode are described in the header. In addition, 1280×1024 as the numbers of pixels in the horizontal and vertical directions of the reference image G1, a11 as the starting address of the reference image data set G1, a12 as the starting address of the converted three-dimensional data set V1, a13 as the ending address of the converted three-dimensional data set V1, Z=0 as the reference plane position, 900 mm to 1000 mm as the distance range for calculation, 900 mm as the closest distance in the converted three-dimensional data set V1 and a14 as the address of the distance data, 1000 mm as the farthest distance in the converted three-dimensional data set V1 and a15 as the address of the distance data, 12.5 mm as the intervals of the divided distance ranges, and h11 to h18 as the addresses of the last distance data in the ranges H11 to H18 are described in the header.

As has been described above, in the second embodiment, the converted three-dimensional data set V1 is divided at the predetermined intervals only in the range from the closest distance D1 and the farthest distance D2 in the distances represented by the distance data. Therefore, the three-dimensional data file F0 can be generated only in the range of the existing distance data, which leads to reduction in an amount of data in the three-dimensional data file F0.

In the first and second embodiments, the distance data (x, y, X, Y, Z) whose X, Y, and Z values are FF are deleted at the time the distance data are combined with the image data set G1. However, the three-dimensional data file F0 may be generated without deletion of the distance data. In this case, a number different from 1 and 2 as the processing modes in the first and second embodiments is used for the processing mode.

In the first and second embodiments described above, only the image data set G1 of the reference image is included in the three-dimensional data file F0. However, the image data set G2 of the matching image may be included therein. In this case, the image data set to be combined with the converted three-dimensional data set V1 may be either the image data set G1 or G2. In this case, a number different from 1 and 2 as the processing modes in the first and second embodiments is used for the processing mode.

The three-dimensional data file F0 may be generated only to include the converted three-dimensional data set V1 without the image data sets G1 or G2. In this case, it is preferable for files having the same file name as the three-dimensional data file F0 but having different extensions to be generated for the image data sets G1 and G2 separately from the three-dimensional data file F0. In this manner, the files of the image data sets are related to the three-dimensional data file F0, although how the three-dimensional data file F0 is related to the files of the image data sets is not necessarily limited thereto. For example, the three-dimensional data file F0 and the files of the image data sets may be recorded in the same folder as long as the three-dimensional data file F0 and the files of the image data sets can be integrated inseparably. In the case where the three-dimensional data file F0 including only the converted three-dimensional data set V1 is reproduced, only a three-dimensional image of a specified distance range may be reproduced.

In the first and second embodiments, the two imaging units 21A and 21B are installed and the three-dimensional data set V0 is generated from the two images. However, three or more imaging units may be installed. In this case, the three-dimensional data set V0 is generated from three or more image data sets obtained by the imaging units.

In the first and second embodiments, the three-dimensional data file F0 is generated in the stereo camera 1. However, the file generation unit 24 and the data conversion unit 24A may be installed separately from the stereo camera 1. In this case, the three-dimensional data file F0 is generated by outputting the image data sets G1 and G2 of the reference image and the matching image and the three-dimensional data set V0 to the external file generation unit 24 and the external data conversion unit 24A.

The three-dimensional data set V0 is generated from the image data sets G1 and G2 of the reference image and the matching image obtained by the imaging units 21A and 21B in the stereo camera 1 in the first and second embodiments. However, the image data sets G1 and G2 of the reference image and the matching image generated in advance by photography and recorded in the recording medium 29 may be read from the medium, to generate the three-dimensional data file F0 from the image data sets G1 and G2 having been read.

The distance data are arranged in ascending order of distance from the reference plane in the first and second embodiments. However, the distance data may be arranged in descending order of distance from the reference plane.

Although the embodiments of the present invention have been described above, a program that causes a computer to function as means corresponding to the file generation unit 24 and the data conversion unit 24A and to execute the processing shown in FIGS. 7, 13, and 17 is also an embodiment of the present invention. A computer-readable recording medium storing such a program is also an embodiment of the present invention.

What is claimed is:

1. A file generation apparatus comprising:
three-dimensional data acquisition means for obtaining a three-dimensional data set comprising distance data representing a three-dimensional shape of a subject;
data conversion means for generating a converted three-dimensional data set by arranging the distance data according to distance; and
generation means for identifying the distance data at a boundary in the case where the converted three-dimensional data set is divided at predetermined distance intervals and for generating a three-dimensional data file storing the converted three-dimensional data set and storage location information representing a storage location of the identified distance data in the file.

2. The file generation apparatus according to claim 1, wherein the generation means divides the converted three-dimensional data set at the predetermined intervals only in a range from a closest distance and a farthest distance among distances represented by the distance data.

3. The file generation apparatus according to claim 1, further comprising, in the case where the three-dimensional data set is generated from two-dimensional image data sets obtained by photographing the subject, two-dimensional image data acquisition means for obtaining the two-dimensional image data sets, and
the generation means generating the three-dimensional data file by relating one or more of the two-dimensional image data sets to the converted three-dimensional data set.

4. The file generation apparatus according to claim 3, wherein the three-dimensional data acquisition means obtains the three-dimensional data set by generating the three-dimensional data set from the two-dimensional image data sets.

5. The file generation apparatus according to claim 3, wherein the generation means generates the three-dimensional data file by adding information on pixel positions in an image represented by one of the two-dimensional image data sets to the distance data at the pixel positions.

6. The file generation apparatus according to claim 5, wherein, in the case where the distance data corresponding to a portion of the pixel positions in the image represented by the two-dimensional image data set cannot be obtained, the generation means deletes the distance data corresponding to the portion of the pixel positions.

7. The file generation apparatus according to claim 3, wherein, in the case where the distance data representing the same distance exist at a plurality of positions, the data conversion means arranges the distance data in order of the corresponding pixel positions in the image represented by the two-dimensional image data set.

8. A three-dimensional shape reproduction apparatus comprising:
file acquisition means for obtaining the three-dimensional data file generated by the file generation apparatus of claim 1;
specification means for receiving specification of a reproduction distance range regarding the three-dimensional shape, based on the storage location information included in the three-dimensional data file; and
reproduction means for obtaining a three-dimensional data set comprising the distance data corresponding to only the reproduction distance range from the three-dimensional data file and for reproducing an image of the three-dimensional shape represented by the three-dimensional data set of the reproduction distance range.

9. A three-dimensional shape reproduction apparatus comprising:
file acquisition means for obtaining the three-dimensional data file generated by the file generation apparatus of claim 3;
specification means for receiving specification of a reproduction distance range regarding the three-dimensional shape, based on the storage location information included in the three-dimensional data file; and
reproduction means for obtaining a three-dimensional data set comprising the distance data corresponding to only the reproduction distance range from the three-dimensional data file and a corresponding portion of the two-dimensional image data set or sets related to the three-dimensional data set of the reproduction distance range, and for reproducing an image of the three-dimensional shape represented by the three-dimensional data set of the reproduction distance range and a two-dimensional image represented by the portion of the two-dimensional image data set or sets.

10. A file generation method comprising the steps of:
obtaining a three-dimensional data set comprising distance data representing a three-dimensional shape of a subject;
generating a converted three-dimensional data set by arranging the distance data according to distance;
identifying the distance data at a boundary in the case where the converted three-dimensional data set is divided at predetermined distance intervals; and
generating a three-dimensional data file storing the converted three-dimensional data set and storage location information representing a storage location of the identified distance data in the file.

11. The file generation method according to claim 10, further comprising the step of, in the case where the three-dimensional data set is generated from two-dimensional image data sets obtained by photographing the subject, obtaining the two-dimensional image data sets, and
the step of generating the three-dimensional data file being the step of generating the three-dimensional data file by relating one or more of the two-dimensional image data sets to the converted three-dimensional data set.

12. A three-dimensional shape reproduction method comprising the steps of:
obtaining the three-dimensional data file generated by the file generation method of claim 10;
receiving specification of a reproduction distance range regarding the three-dimensional shape, based on the storage location information included in the three-dimensional data file;
obtaining a three-dimensional data set comprising the distance data corresponding to only the reproduction distance range from the three-dimensional data file; and
reproducing an image of the three-dimensional shape represented by the three-dimensional data set of the reproduction distance range.

13. A three-dimensional shape reproduction method comprising the steps of;
obtaining the three-dimensional data file generated by the file generation method of claim 11;
receiving specification of a reproduction distance range regarding the three-dimensional shape, based on the storage location information included in the three-dimensional data file;
obtaining a three-dimensional data set comprising the distance data corresponding to only the reproduction distance range from the three-dimensional data file and a corresponding portion of the two-dimensional image data set or sets related to the three-dimensional data set of the reproduction distance range; and
reproducing an image of the three-dimensional shape represented by the three-dimensional data set of the reproduction distance range and a two-dimensional image represented by the portion of the two-dimensional image data set or sets.

14. A computer-readable recording medium storing a program that causes a computer to execute a file generation method, the program comprising the procedures of:
obtaining a three-dimensional data set comprising distance data representing a three-dimensional shape of a subject;
generating a converted three-dimensional data set by arranging the distance data according to distance;
identifying the distance data at a boundary in the case where the converted three-dimensional data set is divided at predetermined distance intervals; and
generating a three-dimensional data file storing the converted three-dimensional data set and storage location information representing a storage location of the identified distance data in the file.

15. A computer-readable recording medium storing the program of claim 14, the program further comprising the procedure of, in the case where the three-dimensional data set is generated from two-dimensional image data sets obtained by photographing the subject, obtaining the two-dimensional image data sets, and
the procedure of generating the three-dimensional data file being the procedure of generating the three-dimensional data file by relating one or more of the two-dimensional image data sets to the converted three-dimensional data set.

16. A computer-readable recording medium storing a program that causes a computer to execute a three-dimensional shape reproduction method, the program comprising the procedures of:
obtaining the three-dimensional data file generated by the file generation method of claim 10;
receiving specification of a reproduction distance range regarding the three-dimensional shape, based on the storage location information included in the three-dimensional data file;
obtaining a three-dimensional data set comprising the distance data corresponding to only the reproduction distance range from the three-dimensional data file; and
reproducing an image of the three-dimensional shape represented by the three-dimensional data set of the reproduction distance range.

17. A computer-readable recording medium storing a program that causes a computer to execute a three-dimensional shape reproduction method, the program comprising the procedures of:
obtaining the three-dimensional data file generated by the file generation method of claim 11;
receiving specification of a reproduction distance range regarding the three-dimensional shape, based on the storage location information included in the three-dimensional data file;
obtaining a three-dimensional data set comprising the distance data corresponding to only the reproduction distance range from the three-dimensional data file and a corresponding portion of the two-dimensional image data set or sets related to the three-dimensional data set of the reproduction distance range; and
reproducing an image of the three-dimensional shape represented by the three-dimensional data set of the reproduction distance range and a two-dimensional image represented by the portion of the two-dimensional image data set or sets.
